(19) United States
(12) Patent Application Publication
(10) Pub. No.: US 2024/0224945 A9
(43) Pub. Date: Jul. 11, 2024

(54) DEPLOYABLE MARINE SENSOR SYSTEM

(71) Applicant: SUSTAINABLE MARINE ENERGY LIMITED, Edinburgh (GB)

(72) Inventors: Jason HAYMAN, Edinburgh (GB); Christopher BURDEN, Edinburgh (GB)

(21) Appl. No.: 18/547,222

(22) PCT Filed: Feb. 22, 2022
(86) PCT No.: PCT/GB2022/050485

§ 371 Date: Aug. 21, 2023

(30) Foreign Application Priority Data
Feb. 23, 2021 (GB) 2102570.5
Mar. 30, 2021 (GB) 2104504.2

(51) Int. Cl. A01K 29/00; F03B 17/06; G01S 15/88; H04N 23/54; H04N 23/90

(52) U.S. Cl. CPC A01K 29/005; F03B 17/06; G01S 15/88; H04N 23/54; H04N 23/90; F16M 11/06

(57) ABSTRACT

Deployable system of one or more sensors (116) for incorporation on a marine installation (100). The sensor system comprises a sensor mount (114) securable to the marine installation (100) and a sensor (116) mounted on the sensor mount (114). The sensor mount (114) has a raised configuration and a deployed configuration, such that the sensor (116) is arranged to be held rigidly in place below a hull (102) of the marine installation when the sensor mount (114) is in the deployed configuration. The sensor mount (114) is arranged to rigidly hold the sensor (116) in a higher position in the raised configuration than in the deployed configuration. The sensor system is configured to monitor local wildlife and the interaction of the wildlife with the marine installation (100).

The invention relates in general to marine sensing, and in particular to sensor systems for marine sensing, for example for compliance testing or damage monitoring and avoidance.

An increasing number of installations are being made in the rivers, lakes, and oceans of the world. These marine installations may be installed for any amount of time from mere days to many years. At the same time, increasing note is being taken of the impact of such systems on marine ecosystems which exist in the installation site. A response to this has been to monitor the behaviour of wildlife in regions where marine installations are intended to be installed. This process is sometimes voluntarily but is sometimes a requirement of local government regulations.

In any case, this has a clear environmental benefit in the sense that the behaviour of wildlife near to a proposed installation site can be monitored with a view to minimising the impact of the installation on the ecosystem. Of course, this benefit is two-way. Not only does the ecosystem benefit from minimised impact on its natural activities, but the installation itself can be designed to interact as little as possible with that ecosystem, reducing the likelihood that the installation will be negatively impacted by interactions with wildlife.

Previous approaches to this issue have included installing monitoring stations on the water bed, for example AMP in the USA (developed by the Pacific Northwest National laboratory); FLOWBEC in the UK (developed by the Natural Environment Research Council); and FAST in Canada (developed by the Fundy Ocean Research Center for Energy). These devices are intended to be left in place for many years, with the results being harvested typically much later. Given the inaccessibility of the installations, there has been a strong financial disincentive against repeatedly raising and lowering the installation. Broadly, once installed these installations remained in place until the study was complete or a serious malfunction occurred necessitating the retrieval of the equipment. While much has been learned from this approach, the studies were inflexible and limitations on e.g. storage and processing capabilities has meant that the studies were necessarily limited in their ability to explore new avenues reactively, once the project is underway.

The present invention aims to address some or all of the above-noted drawbacks.

Disclosed herein is a deployable sensor system for incorporation on a marine installation, the sensor system comprising: a deployable sensor mount securable to the marine installation; and a sensor mounted on the sensor mount; wherein the sensor mount has a raised configuration and a deployed configuration; and wherein the sensor is arranged to be held rigidly in place below a hull of the marine installation when the sensor mount is in the deployed configuration and the sensor mount is arranged to be rigidly hold the sensor in a higher position in the raised configuration than in the deployed configuration.

A marine installation in this context is a structure for permanent or semi-permanent deployment in oceans, lakes and/or rivers, typically intended to remain in place for timescales on the order of years or decades. These are usually tethered to the water bed using mooring lines, anchoring cables, etc. and have at least part of the structure underwater, for example. Usually such installations float on the water surface with parts of their hull submerged but with their upper decks above the water line. In some cases, fully submersible installations may be used with the concepts disclosed herein. For example, some flowing water driven turbine devices are designed for operation fully submerged, but within 5 to 20 m of the water surface (and so remain tethered and submerged in a floating equilibrium state). In such examples the sensor system may be arranged to protrude outward from an upper (or side) surface of the marine installation.

As used herein, marine installations can include oil platforms, wind turbine installations, tidal or current based water turbines, FPSO assemblies and so forth. Typically ships, boats, and other moveable vessels are not marine installations in this context as they are not intended to be moored in a single place for long periods or indefinitely. The arrangements described herein could also be used on survey vessels for not only marine wildlife but also bathymetry surveys, etc.

Of course, where the device is fully submerged in this way, the deploying and raising of the sensors as described here may be more complicated, especially where the raised configuration aims to allow the sensor to be accessed for repair, maintenance, etc. In some cases, this issue is addressed by careful design of feedthroughs and seals, in other cases airlocks may be used. In yet further examples, the submerged assembly may be tethered and buoyant, such that the tension in the mooring lines holds the assembly in a state of floating equilibrium at the desired depth. Such an assembly can easily be surfaces by letting out some more mooring line (i.e. via a winch or similar arrangement), thereby allowing the assembly to surface and any maintenance or repair be enacted above the water. The assembly can then be submerged again by winching the mooring lines in again to pull the assembly below the water line and back to the desired operational depth.

Regarding terms like “below” and “higher”, which require the definition of a vertical axis, the following convention will be used. When floating on calm flat water, “up” and “down” align with the local gravitational field. When water dynamics are included these directions change as the marine installation pitches and rolls. Therefore, for consistency, the up and down directions are defined relative to the orientation of the marine installation in calm flat water. That is to say that directions which would be parallel with the local gravitational field when the marine installation is floating in calm flat water are the “down” direction and directions which are antiparallel to the local gravitational field under these conditions are the “up” direction. These directions are taken as fixed relative to the reference frame of the rigid body of the marine installation (and not, for example, in an absolute sense relative to the Earth), and retain their definition as the “down” and “up” directions, even when they no longer align (or anti-align) with the local gravitational field. Related terms such as higher, lower, above, below, etc. shall be construed accordingly. Similarly, horizontal directions shall be those lying in a plane perpendicular to the up-down axis. Terms such as “below” and “beneath” do not necessarily mean directly below (although they certainly include this), simply that one part is at a lower height than another.

The deployable sensor mount results in a sensor mount and sensor which are both rigidly fixed in place, but for the degree of freedom provided between the deployed and raised configurations (although the sensor is selectively held rigidly in position and orientation when in the raised or deployed configuration, of course). This results in a vertical displacement of the sensor, increasing the draft of the marine installation and placing the sensor away from the hull to allow a clearer view of the exterior of the marine installation. Because the sensor is held rigidly here, an operator can be confident in the repeatability of the measurements as they are taken from the same location and orientation relative to the hull of the marine installation, even when measurements are taken days or even years apart from one another.

The measurements can be taken continuously or on a schedule, and data from the sensors can be monitored and processed in real time, if needed. This allows for a much more flexible approach to environmental monitoring, since instant feedback is available, and the surface-based deployment means that data build-up can be prevented or mitigated by transmitting as much data as needed back to shore. Indeed, remote processing of the data can even be implemented to reduce the computational burden out at sea. Finally, in situ real time monitoring of the actual installed structure allows for much more realistic feedback on the actual response of the local ecosystem to the marine installation (and vice-versa). The sensors installed on such a marine installation can be thought of as a test vessel, meaning that the actual marine installation is installed in a manner to allow it to remain in place for years. The sensors can determine the actual impact of the installation on the ecosystem, rather than passively and unobtrusively monitor wildlife going about its business, as in previous water bed based systems.

The sensor mount (and therefore also the sensor) is selectively deployable, meaning that an operator can control when the sensor is deployed and retracted. For example, the sensors can be generally deployed for the period during which measurements are to be taken, but can be raised to perform repair, cleaning, maintenance, etc. of the sensor, to move the installation to a new site, or to protect the sensors during transient events such as rough seas.

Where fixed position and orientation are used here, this is with respect to the expected position of the sensor and the sensor mount relative to the marine installation, when the sensor mount has been secured to the marine installation. It will be noted that the disclosure extends to just the sensor mount, suitable for installing on a marine installation, and in such cases, the sensor mount itself is arranged to hold the sensor rigidly relative to a device to which the sensor mount can be secured. Therefore, as used herein, when the position, orientation or arrangement of a particular feature is described with respect to the marine installation, this shall be interpreted as covering also the expected position of the marine installation when the sensor mount is appropriately secured to the marine installation. This arrangement can be useful for example to retrofit existing marine installations with the advantageous apparatus described herein.

Where the hull of the marine installation is referred to, this means the generally downward facing part of the installation, which interfaces with the water. In some cases, this may be a single hull (as in most FPSO vessels, for example), or there may be multiple hulls, as in e.g. catamarans, trimarans, etc. In these latter cases, “hull” refers to whichever portion of whichever hull the sensor is intended to protrude out of.

The disclosure also extends to a marine installation having the sensor system described above incorporated thereon. In other words, the sensor system described above may further include a/the marine installation to which it is secured.

The marine installation may include an external recess, a feedthrough and/or a moonpool in the hull for receiving the sensor mount and/or accessing the sensor when the sensor mount is in the raised configuration. This allows the sensor mount to be retracted largely or entirely within the hull of the marine installation to reduce draft (e.g. for towing the installation to the installation site) and also to protect the sensor form inadvertent damage.

In addition, where moonpools or feedthroughs are used, the sensor mount can allow the sensor to be accessed from a dry space on the marine installation for repair, cleaning (e.g. removal of biofouling), maintenance, or other upkeep type activities. In some cases, the moonpool may be better described as a sealed borehole extending entirely through the hull. That is, the internal space of the hull is partitioned off from the outer environment (in a watertight and airtight manner) leaving a borehole directly connecting the deck and the hull.

The marine installation may further include a plurality of sensor mounts secured to the marine installation, each sensor mount having a raised configuration and a deployed configuration and each sensor mount having at least one sensor mounted thereon.

These sensor mounts operate in broadly the same manner as those described above, in particular regarding the mounting of a sensor and the operation of deploying and raising the sensor mount to change the sensor positions. Different sensor mounts may be provided with different deployment motions, for example some may swing downward while others may slide between their various configurations. In some cases, one, some or all sensor mount(s) may have more than one sensor mounted thereon.

Sensors may be located at the lower end of the sensor mount (optionally in a housing or gondola). The sensors, (and optionally their housings) may be completely interchangeable via a standardised bolting interface to suit any type of sensor desired. This even allows for articulated bulbs, wings, drogues, and towed arrays, as needed for any given installation. Where sensors or sensor mounts have protective and/or hydrodynamic fairings associated with them, in some cases, the fairing is removable along with the sensor.

This allows the marine installation to be provided with an array of sensors, which allow monitoring of a particular region or volume of water located relative to the installation. the array of sensors can be appropriately distributed and positioned/oriented to monitor one or more region of particular interest, adaptable to the specific use case intended.

At least one sensor mount may be deployable independently of at least one other sensor mount. That is, in some cases, all sensor mounts may be independently controllable of one another. In other examples the sensor mounts may be deployable selectively in groups. For example, sensors of the same type may be deployed together in groups.

The, some, or each sensor mount(s) may be removeable from the marine installation. Where in some cases the sensor may be detachable from the sensor mount, in this example the entire mount may be removeable. This can allow a malfunctioning sensor (and/or sensor mount) to be replaced in its entirety for a quick return to operation. Alternatively, since the intention is that these can be test installations to perform in situ measurements to confirm compliance of the marine installation with local regulations, once the necessary testing has been performed, the sensor mount(s) can be removed and fitted to a new installation to complete its own compliance testing. This ability to reuse sensors is yet another positive environmental contribution. Where the sensor mount is provided in a moon pool or sealed borehole arrangement, when the sensor mount is removed, the hole which is left may be filled with a plug or cap, for example, if needed.

The or each sensor mount may be slidably secured to the marine installation, to allow the transition between the raised and deployed configuration. For example, the transition between the raised and deployed configurations of the, some, or each sensor mount(s) may include(s) the sensor mount(s) sliding in a generally vertical direction relative to the marine installation. Of course, once the sensor mount is arranged in the raised or lowered configuration, it can be locked in place to retain the sensor in a desired position relative to the marine installation. As an alternative, the sensor mount may be pivotably secured to the marine installation. This allows transitions between the raised and deployed configurations by rotating the sensor mount about a pitch or roll axis of the marine installation. This is less convenient for allowing the sensor to be repaired or cleaned in situ but does provide the advantages associated with reduced draft and improved damage resistance of the sensor when the sensor mount is in the raised configuration.

The sensor mount may be selectively lockable at one or more configurations intermediate between the raised and deployed configurations. That is to say, the deployed configuration can be thought of as the fully deployed configuration, resulting in the sensor being positioned as low as possible, i.e. maximising the distance below the hull where the sensor is. However, the motion between the raised and deployed configurations can be halted by a system operator in at least one location partway between the two extreme configurations. In some cases, there may be specific graduations at which the motion is haltable. In other cases, the sensor mount may be haltable at any configuration between fully raised and fully deployed. That is the locking locations may have the form of a continuous variable. Locking in this context simply means holding the sensor rigidly at a fixed location relative to the marine installation. It is as rigidly held when locked at an intermediate position as it is when it is in the raised or lowered position.

The, some, or each sensor(s) may include(s) one or more of: a camera; a sonar system; and/or a wildlife detector. In this context a sensor can include an emitter-receiver pair as in active sonar, but also in other cases. As a simple example a camera may be paired with a light/laser system to illuminate all or part of the field of view of the camera and improve visibility.

In this case a camera may include any sensor of electromagnetic information for forming an image, including visible light, infrared, or other parts of the electromagnetic spectrum. Where a paired light source is provided, this operates at a frequency appropriate for use with the camera. The camera may include still cameras or cameras with video capabilities (or both). The cameras may also include automated image processing including image recognition processes running on the cameras themselves or automatically on their output.

Sonar includes active sonar, passive sonar, etc. In some cases, a very simple sonar system may be employed, comprising a simple emitter-receiver pair. Since the sensors are intended to be mounted in a fixed location relative to the hull of the installation, which is itself usually far from other artificial sound-reflective objects, the reflections from the marine installation itself are a constant background to the sonar system. These can be filtered out or otherwise ignored, leaving only changes from this background as the relevant signal. In simple sonar systems where only advanced warning of something is needed (and may be a rough estimate of its size), the emitter-receiver pair can be quite simplified. In other cases, more sophisticated 3D modelling may be required, which necessitates a more complicated sonar system. In any case, much like the camera system, the sonar system can be configured to automatically recognise certain signals, and categorise these into e.g. large mammal, shoal of fish, etc.

Wildlife sensors include as examples the F-POD by Chelonia™ and the Vemco™ fish tracking system. These are bundles of sensors, including subsea acoustic measurement and processing to provide reliable long-range identification of both the presence of marine life and the species so detected, while filtering out other sources of noise, such as sonar, boat motors, etc. In addition, further sensors may be used to boost the analysis, including, but not limited to: thermometers, salinity (or conductivity) sensors, accelerometers, and magnetic or electric field sensors.

Where multiple sensors are present, they may cooperate to improve the measurement. For example, multiple of the same type of sensor can be used for verification and fine tuning of each other's findings. Different types of sensor can also be used for verification and fine tuning but may also be used to enhance each other's measurements since there may be certain things which one type of sensor can detect which another type cannot (or at least, not as clearly).

The, some, or each of the sensor(s) may be located adjacent the hull of the marine installation when its/their respective sensor mount(s) is/are in the raised configuration. 12. Optionally the, some, or each of the sensor(s) is/are located within the hull of the marine installation when its/their respective sensor mount(s) is/are in the raised configuration. In other words, the sensor may actually be inside the envelope of the hull, or just lie very close to the external surface of the hull. The envelope of the hull, as used here, may be thought of as follows. Where a bore hole is made through a hull, the shape of the hull prior to the hole being there is the envelope. Anything located internally of this outer surface is within the envelope of the hull, even though (since a hole has been bored) there is no actual hull material located between such a location and open water.

The, some, or each sensor(s) may be rotatable relative to the marine installation. In some cases, the entire sensor mount may be able to rotate, bringing the sensor with it. Rotation is usually about a generally vertically aligned axis e.g. in a yaw direction relative to the marine assembly. As noted below, the sensor mount is not always circular in cross section and may fit into a borehole or moonpool having the same cross-sectional size and shape as it, so may not be able to rotate as a single unit. In such cases, there may be a shaft within the sensor mount which rotates relative to the marine installation and causes a rotation of the sensor. In yet further cases, the mounting of the sensor on the sensor mount may itself have a rotational degree of freedom. In conjunction with the slidable depth adjustment as described above, allowing intermediate configurations between raised and deployed, the rotational degree of freedom gives potential access to a sensor which can cover its local environment in full 3D, broadly in a cylindrical coordinate system, by changing the field of view (or field of maximum sensitivity for e.g. sonar) of the sensor(s).

Optionally each rotatable sensor is selectively lockable at two or more orientations. That is an operator can orient the sensor to point in at least two directions. As with the slidable locking feature discussed above, the rotational locking feature may be a continuous one, in that the sensor can be locked at any orientation between two extremes (or indeed at any point around a full 360° rotation). Locking in this context simply means holding the sensor rigidly at a fixed orientation relative to the marine installation.

The, some, or each of the sensor mount(s) may be an elongate, rigid beam. This provides a simple means for allowing the sensor to be spaced a particular and controllable distance from the hull. The sensor is mounted toward one end of the beam. For example, where the sensor mount is pivoted, it is pivoted at one end and the sensor is mounted at the other. Where the sensor mount slides between configurations, the sensor is mounted at its lower end.

The, some, or each sensor mount(s) include(s) one or more lumens for allowing control signals, sensor data, electrical power and/or motive power to be transmitted between the marine installation and the sensor(s). That is to say that wires, cables, hydraulics, pneumatics, axles, rack, and pinions, etc. may be located within the lumen and be used to transmit information, electrical power, or motive power to or from the sensor, as needed.

Control signals may be used to rotate a rotatable sensor, turn sensor on or off, adjust parameters of measurement or emission, etc. e.g. frequency, intensity, duty cycle or pattern of emission, measurement parameters such as focal point or snapshot timings, framerate, sensitivity to frequencies/spectral weighting, etc.

Sensor data may be information directly measured or information which has been processed by the sensor, to be fed back to subsequent processing steps or for human review.

Electrical power may be used to power the sensor or its rotation, or to control the deployment and/or raising of the sensor mount. In other examples motive power may be supplied directly to achieve the changes in position or orientation of the sensor.

An outer surface of the, some, or each sensor mount(s) may include(s) a hydrodynamic fairing. This can help to reduce drag loads on the marine installation when the sensor mount is in the deployed configuration, thereby reducing the requirements of any tethering system. In addition, the fairing can be shaped to reduce vortex induced vibrations as water flows past the sensor mount. The fairing may be non-round, for example teardrop-shaped in cross section (when cut by a horizontally level plane). The non-round shape may fit into a feedthrough or moonpool of corresponding shape and size, which may help to support the sensor mount and hold the sensor irrotationally. In other cases, non-round sensor mounts may be supported within a borehole of sufficient girth to allow the sensor mount to rotate, for example to allow the sensor's orientation to be adjusted as set out above.

The sensor mount is in some cases larger than the diameter of its respective moonpool or feedthrough. Raising and lower can be achieved in such cases by subsea removal and/or addition of the mount to/from the assembly. Additionally, an articulated sensor mount can be provided to allow for raising and lowering, in cases where the sensor mount is larger than the moonpool in only one dimension. For example a 1 m long 100 mm diameter sensor could be deployed through a relatively narrow (but at least 100 mm diameter) through hole, in a vertical arrangement, and the articulated sensor mount can then be rotated to align the sensor horizontally, once below the keel plate or outer hull.

The, some, or each sensor(s) may be removeable from its/their respective sensor mount(s). In other words, the sensor(s) may be detachably mounted to its/their sensor mount(s) to allow quick and easy replacement of damaged or malfunctioning sensors, or to allow the sensor to be taken to a more convenient location to be repaired. In other cases, this may be helpful for upgrading (or otherwise changing the operational parameters of) the sensor or for removal to fit the sensor to an entirely different marine installation once the necessary measurements have been taken.

Since in some examples only the sensor is removed, the sensor mount remains in place to act as a plug for any through holes in the hull and also as a structural member.

The sensor system or marine installation may further comprise an on-board processor for processing output from the, some, or each sensor(s). This can allow real-time monitoring of subsea conditions. The processing systems can be located in human accessible parts of the marine installation, and above the waterline of the installation. This allows the generally expensive, fragile, water-sensitive processing equipment to be situated in a safer place, while still gaining the benefits of local data processing and analysis. In some cases, some or all of the information may be transmitted to shore for further processing (i.e. more compute-time intensive analyses) or for storage and record keeping activities. This remote link can also be used to remotely monitor the marine installation, saving time and expense by ensuring that crews are only sent to visit the site when absolutely necessary.

As used herein, processing includes receiving signals and converting to a human-readable format and/or may also include generating alerts and suggesting courses of action to avoid or mitigate the situation, or even automatically taking such actions.

The sensor(s) may be arranged to monitor sensitive and/or fragile parts of the marine installation. These are the parts most likely to suffer damage and therefore the parts which there is the most value in monitoring. In other examples, the parts of the marine installation which are deemed most likely to impact marine life are monitored to determine the extent of the impact.

In some cases, in response to a detection by the sensor(s) that an object is likely to collide with the sensitive and/or fragile parts of the marine installation, the sensor system is configured to issue an alert to an operator and/or take appropriate action to minimise damage.

As used herein “likely to collide” includes in a flow path towards the part in question and therefore likely to shortly collide with (i.e. upstream of it). Similarly, things which are close to the part in question, but local flow conditions render it unlikely to collide can be discounted.

The marine installation may be a flowing-water-driven turbine assembly. In this case, the fragile parts of the installation may be the turbines and more specifically the turbine blades. There is a symmetry here in that the spinning turbines probably also present the greatest risk to marine life, so it is important to monitor these parts of the assembly for two reasons. As an example, one or more sensors can monitor the turbines in the following way. Cameras can be used to monitor the turbines (and their blades directly). The upstream region (volumes of water soon to flow over the blades can be monitored with sonar. Longer range wildlife sensors can be placed further away to give a long range indication of the wildlife in the area in general.

Sonar is good for the upstream measurement as it is quite reliable and can be reasonably simple and low power. As noted above, the simplicity of the system means that a very simple emitter-receiver pair can be used for monitoring a reasonably small upstream region, and the reflections from the marine installation itself are constant and can be filtered out automatically (emission/detection can be angled to avoid picking these up at all. On the other hand, sonar is less suited to direct monitoring of the turbines as the moving blades create a complex and ever changing picture, hence the preferred use of cameras for this role.

As used above, in the context of turbine assemblies as the marine installation, evasive action may include raising the turbines, slowing or braking the turbines or deploying a deflector grids, such as a coarse metal mesh at an angle to the flow to intercept the wildlife and deflect it away from the blades.

The, some, or each sensor(s) may has/have a protective cage for protecting the sensor. This can take the form of a metal (e.g. steel) cage around the sensor, helping to protect the sensors directly from wildlife or accidental knocks from human activity. The cage can be arranged not to block the sensing (i.e. line of sight or emission and reception of sonar signals. Sonar can filter any residual reflections out as standard, in the manner discussed above regarding reflections from the hull. Where the sensor is rotatable, the cage may also rotate to ensure correct alignment between sensor and cage.

Also disclosed herein is a method of installation of a marine installation of the type described above, the method comprising the steps of: (a) positioning the or each sensor mount in its/their raised configuration; (b) towing the marine installation to an installation site; and (c) installing the marine installation at the installation site. Where the marine installation is a water-driven turbine assembly, the turbines themselves may also be raisable in a similar manner, to reduce draft when towing to site.

The installation step may include for example any or all of: installing anchors in a water bed; attaching mooring lines to anchoring points on the water bed; and attaching mooring lines to the marine assembly. In whichever manner the installation is performed, once installed the sensors may be deployed as needed in the manner described in detail above, to allow information to be collected.

Optionally the method further comprises the step of (d) deploying the sensor mount(s) to perform data collection using the sensor(s). Optionally the method further comprises the step of (e) removing the sensors for use elsewhere once sufficient data has been collected. The sensors can be deployed as needed or as permanent (or semi-permanent) fixtures. Semi-permanent means that the sensors are deployed unless there is a good reason to raise them such as rough seas indicating likely damage, or malfunction or damage requiring repair or maintenance work to be performed.

As described above, the position and/or orientation of the sensors may be adjusted as needed. Onboard processing can be used in an ongoing fashion to assess when sufficient data has been collected to trigger step (e). Or step (e) can be performed after a predetermined threshold has been reached (an amount of data collected, an amount of time spent collecting, etc.)

Examples will now be described with reference to the Figures, in which:

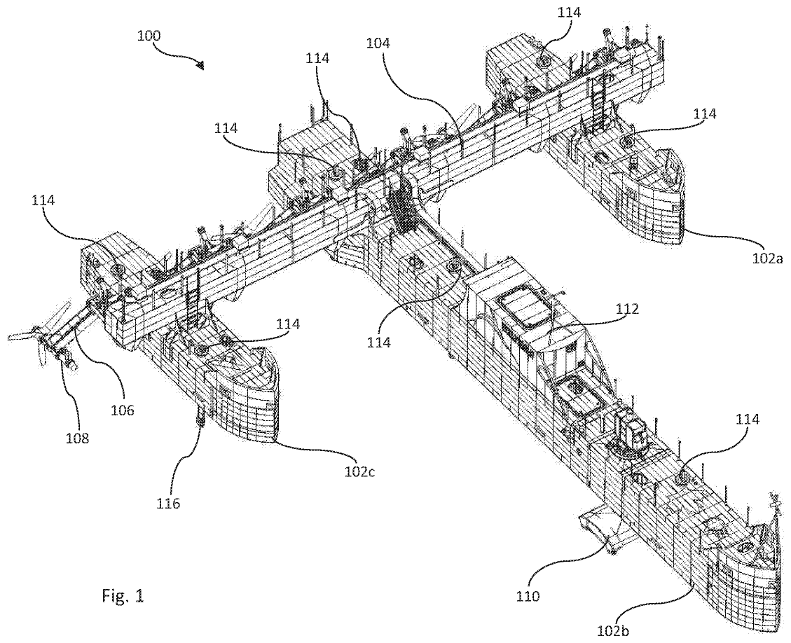

FIG. 1 shows a perspective view of a marine installation according to the present disclosure.

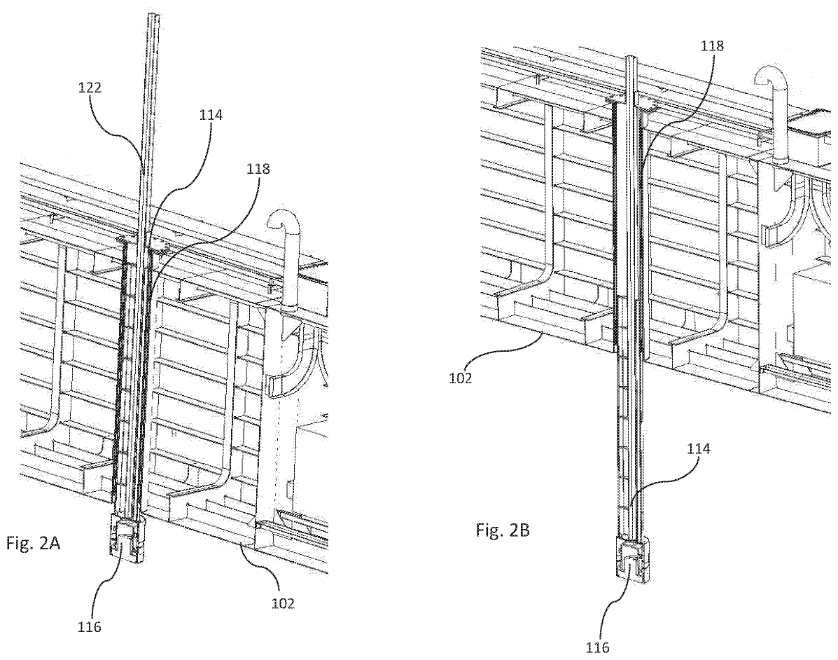

FIGS. 2A and 2B show a cross-sectional detail of a sensor mount according to the present disclosure in the raised and deployed configurations, respectively.

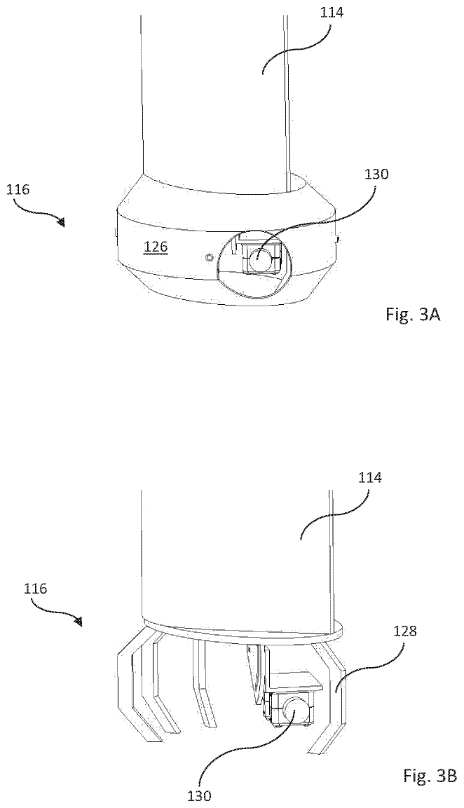

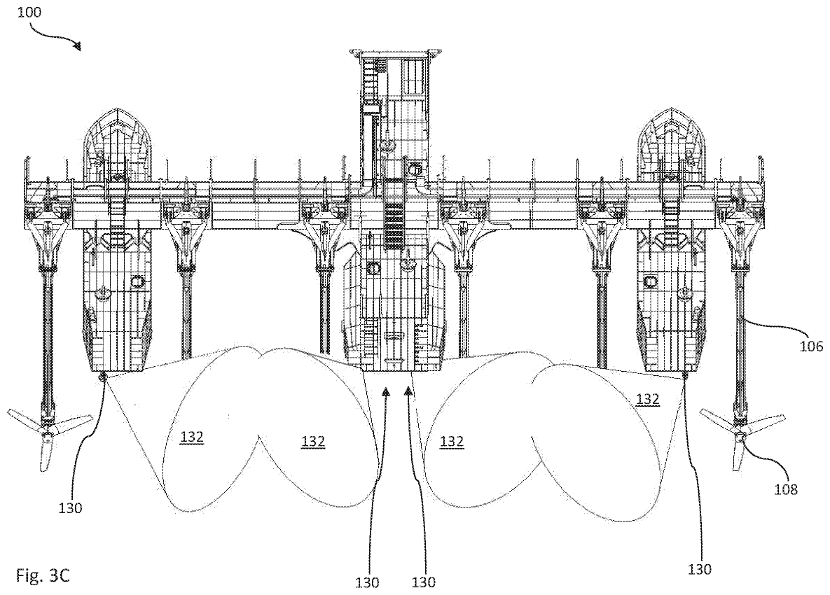

FIGS. 3A and 3B show detailed views of a camera as a sensor according to the present disclosure, the camera being shown with and without a protective fairing.

FIG. 3C shows a perspective view of the marine installation of FIG. 1 from behind, highlighting the field of view of the cameras.

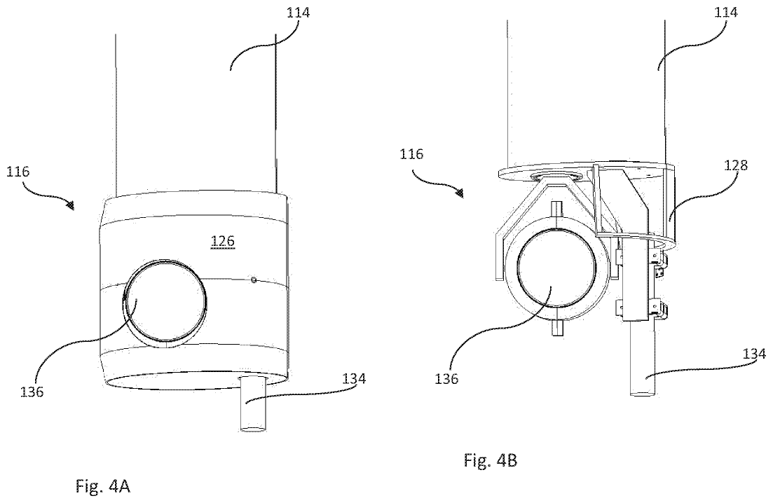

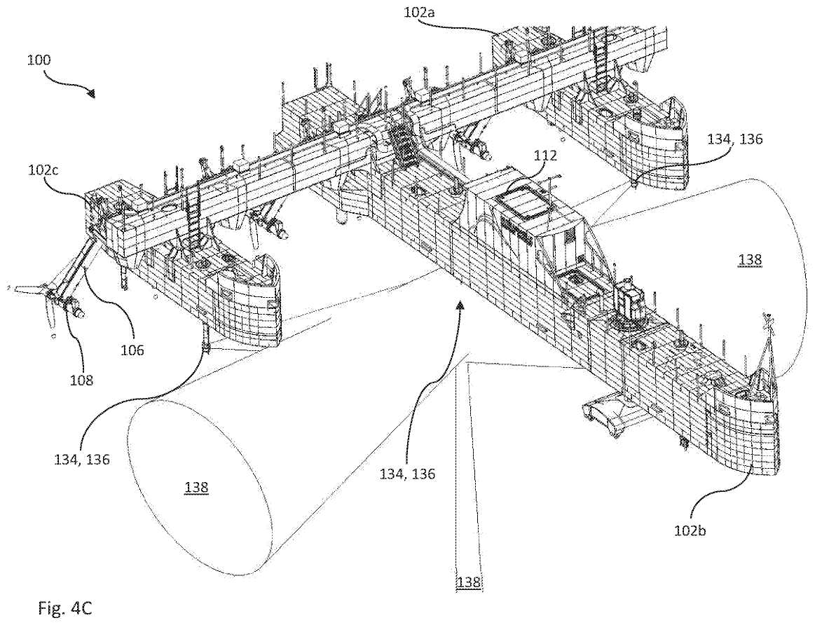

FIGS. 4A and 4B show detailed views of a sonar system as a sensor according to the present disclosure, the sonar system being shown with and without a protective fairing.

FIG. 4C shows a perspective view of the marine installation of FIG. 1, highlighting the region of peak sensitivity of the sonar systems shown in FIGS. 4A and 4B.

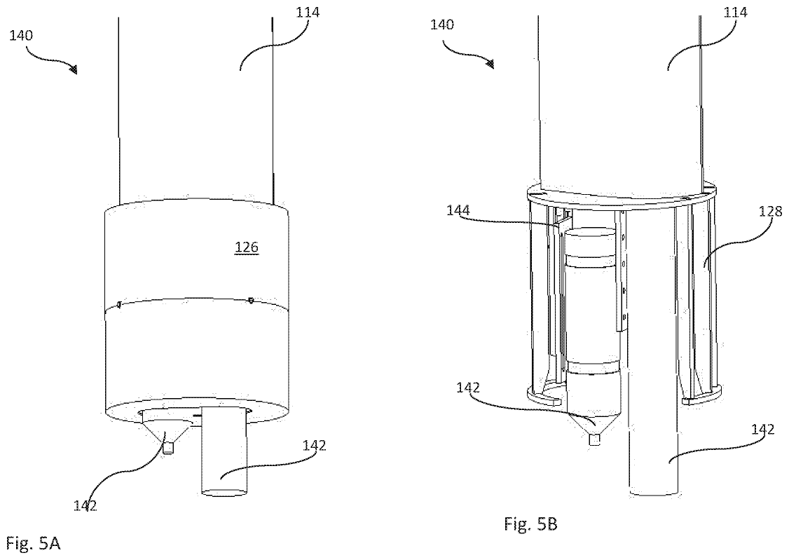

FIGS. 5A and 5B show detailed views of a wildlife sensor as a sensor according to the present disclosure, the wildlife sensor being shown with and without a protective fairing.

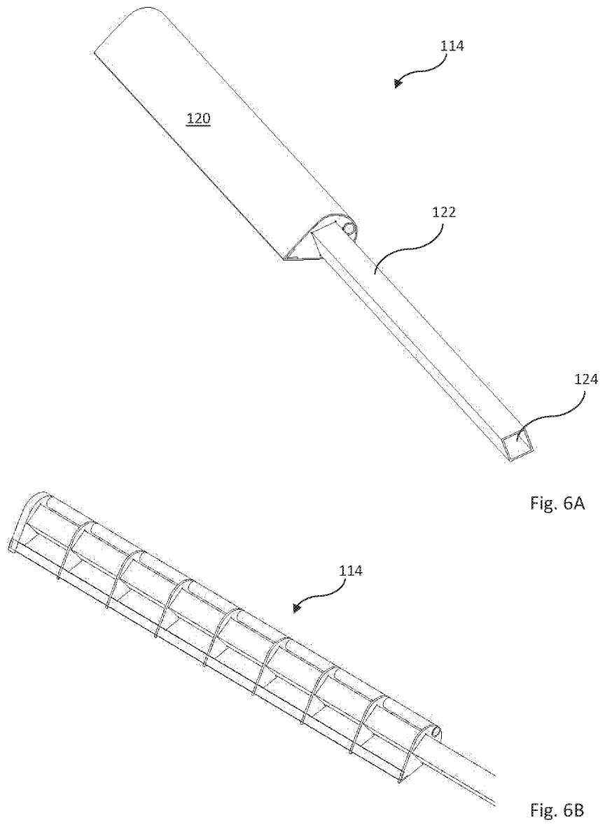

FIGS. 6A and 6B show detail of a sensor mount according to the present disclosure, the sensor mount being shown with and without a hydrodynamic fairing.

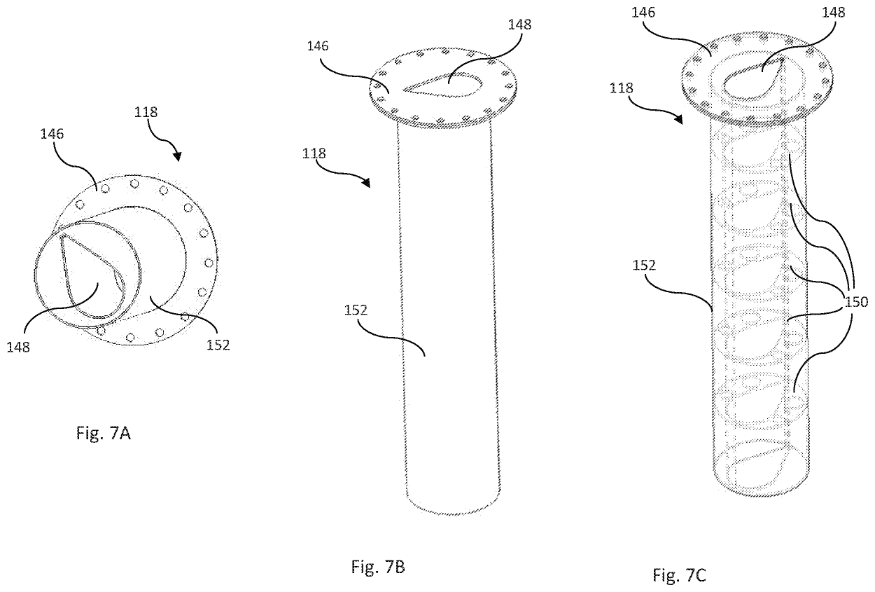

FIGS. 7A and 7B show examples of the sealed bore or moonpool.

FIG. 7C shows the sealed bore or moonpool of FIGS. 7A and 7B with a transparent outer housing to reveal the inner structure.

Consider FIG. 1, in which an example of a marine installation 100 is shown. Here, the marine installation 100 is a flowing water driven turbine assembly. The marine installation 100 a trimaran arrangement having three hulls 102a-c. A central hull 102b is longer than the two side hulls 102a, 102c. All three hulls 102 are joined to one another by a crossbeam 104. This disclosure extends to marine installations of any number of hulls 102 and should not be construed as applying only to trimaran configurations.

Mounted on the crossbeam 104 are six turbine supports 106, each having a turbine 108 secured at a lower end of the turbine support 106. As the techniques described herein are not limited strictly to turbine assemblies such as this, the operation of the turbines 108 will not be discussed in detail here, and the use of turbines 108 as an example system to be monitored should be understood as representing marine installations 100 in general.

The marine installation 100 is shown having a turret mooring 110 on the long central hull 102b. This allows the turbine system to adapt to small changes in local current flow and maximise extraction of energy from the current. Of course, turret moorings 110 are useful in capacities other than in turbine assemblies. Similarly, the present disclosure would work with other mooring types, so the turret mooring 110 will not be described in further detail.

An array of sensors 116 is provided, each sensor 116 being mounted on a deployable sensor mount 114 (not all sensors are visible in this view). The sensor mounts 114 as shown are deployable in a sliding motion as described in more detail below, although in other examples the sensor mounts 114 may be deployed in a swinging, pivoted motion. The array of sensors 116 is spread out in the horizontal plane to cover the area beneath the marine installation 100 (also referred to as the footprint of the marine installation 100). As shown, the sensors 116 monitor a region upstream of rotors and in the near field. In addition, the deployable nature of the sensors 116 means that the sensors 116 can be held rigidly spaced a known and repeatable distance away from the lower surface of the hulls 102 in use, to provide a clearer field of view for the sensors. The sensors 116 can also be retracted to a raised configuration if desired.

As used herein field of view refers to the effective region which a given sensor can monitor, i.e. without encountering obstructions, etc. For a camera, this is a simple line of sight, for sonar line of sight is relevant but the stronger diffraction of sound waves means that there is not an exact correspondence here. Of course, in some cases there may be only one sensor mount 114 and indeed in some cases there may be only a single sensor 116.

A control centre 112 is provided for controlling both the operation of the marine installation itself 100 and the operation of the sensors 116 as described herein. The control centre 112 may also include information processing systems, alert systems, data storage, and so on. Equally, the control centre 112 may be provided with an antenna or other communication means to transmit and receive data or control messages to or from the shore.

It can be seen that the sensors 116 are clustered close to the turbines 108. This is because the turbines 108 are the more fragile or sensitive parts of a turbine assembly. In addition, the turbines 108 represent a risk to marine wildlife, so the interaction of wildlife with the turbines 108 is of key importance in monitoring and compliance testing. Where it is determined by the sensors 116 that an object (wildlife or otherwise) is likely to collide with the turbines 108, an alert may be issued in the control centre 112 to an operator and/or appropriate action may be taken to minimise damage. Evasive action may include raising the turbines 108, slowing or braking their blades, or deploying deflector grids, depending on the exact circumstances.

As noted above, the ability to configure the sensor mounts 114 in a raised configuration reduces the draft of the marine installation 100 and can be used to more efficiently tow the marine installation to a proposed installation site. Once the marine installation is in place, the sensors 116 can be deployed and begin to take measurements.

Once the sensors 116 have collected sufficient information, they may be removed, e.g. for use elsewhere.

Turning now to FIGS. 2A and 2B, where a sensor mount 114 is shown in more detail. The sensor mount 114 is shown extending through a sealed bore 118 (sometimes referred to as a moonpool, depending on the context), which extends through the entire hull 102. That is, the sealed bore 118 creates a generally cylindrical cavity linking the deck to the water facing parts of the hull 102.

In FIG. 2A the sensor mount 114 is shown in a raised or retracted configuration, where most of the sensor mount 114 is above the water line of the marine installation 100. The sensor 116 is mounted at a lower end of the sensor mount 114 and is therefore close to the hull 102 in this configuration. While the sensor 116 is shown as remaining outside the hull 102 (i.e. lower than hull 102), in some cases, the raised configuration may result in the sensor 116 being located within the envelope of the hull 102, (i.e. at a higher position than the closest parts of the hull 102 to the sensor 116). This retracted configuration allows the sensor 116 to gain some protection from the more sturdy hull (especially where the sensor 116 is retracted inside the hull 102) and also reduces the draft of the marine installation 100 to assist in towing the marine installation 100 to the installation site by reducing drag and allowing shallower waterways to be traversed than would otherwise be possible.

In FIG. 2B, the sensor mount 114 is shown in its deployed or extended configuration. In this case, this means that the sensor mount 114 has slid downward to space the sensor 116 beneath the hull 102 by a predetermined distance. Once deployed in this manner, the sensor 116 can be used to monitor the impact of the marine installation 100 on the marine ecosystem at the installation site. This deployed configuration can be used to repeatably position the sensor 116 a known distance from the hull 102 to ensure that the data collected by the sensor 116 is accurate even after many retractions and redeployments.

Where multiple sensors 116 are present (see e.g. FIG. 1), their respective sensor mounts 114 may all operate as set out in FIGS. 2A and 2B, or they may operate in a different manner, e.g. pivoting downward about a pitch or roll axis of the marine installation 100. Each of the multiple sensor mounts 114 may be deployed independently of one another, or in groups. For example, with reference to FIG. 1, the rearmost four sensor mounts 114, which may be cameras viewing the turbines 108, may be deployed together as a group, similarly the middle three sensor mounts 114 may be sonar systems and may be deployed as a group.

Although FIGS. 2A and 2B show only two configurations, in some cases the motion of the sensor mount 114 can be halted at any point between these, to adjust the depth of the sensor 116. A simple locking system can ensure that the sensor 116 is held just as rigidly in these intermediate configurations as it is in the raised and deployed configurations.

The sensor mount 114 may be entirely removeable from the marine installation 100 in some examples. This can assist in accessing the sensor itself 116, for example, to facilitate repairs or other maintenance operations.

Consider now FIGS. 3A to 5B, detailing the sensors 116 in more detail. Each sensor is provided with a protective fairing 126, the fairings 126 each having one or more appropriately sized and shaped apertures in the fairing 126 to ensure that the sensor 116 can still operate despite being largely encased. In addition, the sensors 116 are shown with a bump cage 128—a protective cage of metal (e.g. marine-tolerant steel) to prevent damage to the sensor 116. The bump cage 128 is also arranged so as not to interfere with the operation of the sensor 116.

Any of the sensors 116 shown in these Figures may be rotationally adjustable. That is the sensor 116 can be rotated in a yaw direction to orient the sensor 116 in a different direction. The sensor 116 can be locked at any angular orientation within its range (including up to a full 360-degree range). In conjunction with the depth adjustment described above, this can provide full mapping of the local 3D environment by using a cylindrical coordinate system to change the field of view of a particular sensor 116.

Any of the sensors 116 shown here may be removeable from its/their respective sensor mount(s) 114, for example to replace the sensor 116 or to remove it entirely and reuse it elsewhere.

Turning in particular to FIGS. 3A and 3B, the sensor 116 is shown as a camera 130. The camera may also include a light source (not shown) for emitting light to illuminate the field of view of the camera 130 in some cases. Where the camera 130 is arranged to operate at wavelengths outside the visible part of the electromagnetic spectrum, the light source will be arranged to emit an appropriate wavelength of light to illuminate the scene. The light source may be a simple lamp, or it may be a laser, depending on the context. Where a laser is used additional functionality in terms of ranging may be provided in some cases.

FIG. 3C shows a sub-array of cameras 130 in context and in particular shows the fields of view 132 for each of the cameras 130. Here it can be seen that four cameras 130 collectively view the six turbines 108 (partially blocked by the fields of view 132 in this view, but their location can be inferred as being at the bottom of the turbine supports 106). Note that although the left- and right-most turbines 108 are not obviously in the field of view 132 of any camera 130, in practice the field of view 132 of the two central cameras 130 extends outward far enough to allow the outermost turbines 108 to be viewed.

Turning now to FIGS. 4A and 4B, the sensor 116 is shown as a sonar system comprising a sonar emitter 134 and receiver 136. Specifically, the sonar system is an echosounder and hydrophone system. These two components 134, 136 operate in conjunction with one another to emit pulses of sound underwater and detect reflected pulses. The time delay between the pulses indicates the distance to the object from which the reflection is received. The receiver 136 may be highly directional to determine the direction of the object. The emitter 134 and receiver 136 are controlled collectively to allow the timing measurements to be made accurately, and also to ensure that the direct path between emitter and received does not swamp the desired signal.

In FIG. 4C, the regions of peak sensitivity 138 of the sonar modules 134, 136 is shown. It can be seen that there are two wide angle inward-facing sonar systems 134, 136 on the outermost hulls 102a, 102c and a narrower angled downward facing sonar system 134, 136 in the central hull 102b. In normal usage the region of intersection of these regions 138 is upstream of the turbines, so is placed to detect wildlife or other objects which will soon enter the region of the turbines 108. The central hull 102b may have its sonar system 134, 136 located nearer further forward or rearward of the line joining the sonar systems 134, 136 of the outer two hulls 102a, 102c. This spreads the sonar array over a two-dimensional area and may result in improved monitoring of medium and long range objects.

Turning now to FIGS. 5A and 5B, the sensor 116 is shown as a wildlife sensor 140. As noted above, these are bespoke packages including a variety of sensors including hydroacoustic modules 142 and bespoke on-board processing modules 144. Primarily they are arranged to detect the presence and type(s) of various species of wildlife in a local region.

Specifically, the wildlife sensor 140 may be a VEMCO or F-POD sensor. Both of these operate on the principles of passive acoustic detection. VEMCO sensors pick up sounds from tags secured to previously tagged wildlife. The signal received from such tags can be used to identify specific animals. F-POD sensors monitor the water for dolphin, porpoise and/or whale clicks, thereby helping to identify how many and which species of these creatures are in the vicinity. While each sensor 116 is individually useful, collectively they work together to greatly improve the monitoring. For example, sonar systems 134, 136 are good for upstream monitoring as they are quite reliable and can be reasonably simple and low power to operate. In the example shown in FIG. 4C, they are used to monitor a relatively small region, in which there are unlikely to be unexpected reflections other than the wildlife which they are intended to detect.

However, sonar is less suitable in regions where turbines 108 are located as the moving blades create a complex reflection landscape. Cameras 130 are much more suited to this task.

The wildlife sensor 140 acts to provide a near field (that is close to the installation 100, in time and space, but longer range than e.g. the range to which sonar systems or cameras are effective) picture of the sort of wildlife which may be expected to interact with the marine installation 100. It is of particular interest that the various different types of sensor can communicate with one another (e.g. via mutual connections to control centre 112) to verify data from each other, or to detect things which other sensors are less suited to detecting.

In FIGS. 6A and 6B a detailed view of the sensor mount 114 is shown. Each sensor mount has the form of a rigid beam. In the examples shown a rigid support rod 122 provides strength to the sensor mount 114. The support rod 122 is hollow, providing a lumen 124 which can receive cabling, pneumatic or hydraulic piping, etc. for allowing control signals, sensor data, electrical power and/or motive power to be transmitted between the marine installation 100 and the sensor(s) 116. In FIG. 6B the internal structure of the sensor mount 114 is shown, where a series of spacers are used to give a generally teardrop-shape to the sensor mount 114. In FIG. 6A, an external hydrodynamic fairing 120 is provided. This fairing 120 may help to reduce drag on the sensor mount 114 and also may inhibit vortex induced vibrations.

Where the marine installation 100 is turret moored as in e.g. FIG. 1 the hydrodynamic fairing may also be shaped to reduce swaying in a water current by introducing points of stability spread across the footprint of the marine installation 100.

FIGS. 7A to 7C show examples of the sealed bores 118 of FIGS. 2A and 2B in detail, and separately from the marine installation 100. FIG. 7A is a view from below looking into the channel 148, FIG. 7B is a perspective view from the side and FIG. 7C shows the view in FIG. 7B with an outer housing 152 shown transparent to highlight the internal structure.

As noted above, the sealed bore 118 extends from a portion of the hull 102 (not shown) to a higher portion and is arranged to receive the sensor mount 114. The sensor mount 114 is slidable within the sealed bore 118 to deploy or retract its sensor 116. The sealed bore 118 is mounted to the marine installation 100 by way of a flange 146. The mounting location of the flange 146 on the marine installation may be on an upper surface of the installation 100 as shown in FIGS. 2A and 2B, or it may be internally to the hull to allow an operator to access the sensor mount 114 or sensor 116 from inside the hull 102 (in something more like a moonpool arrangement). In either case, the outer housing 152 prevents ingress of water into the interior of the hull 102.

The channel 148 defined by the sealed bore 118 is shown shaped to correspond to the shape of the sensor mount 114 of FIGS. 6A and 6B. In cases where the sensor mount 114 has a different shape, the cross-sectional shape of the channel 148 may have a corresponding shape. The matching of shapes in this way can help to resist unwanted rotations of the sensor mount 114 and allows effective sealing of the channel 148 against ingress of water.

In FIG. 7C the interior structure of the sealed bore is shown. Specifically, a series of channel supports 150 are arranged along the length of the sealed bore 118. These ensure that there is sufficient rigidity in the construction of the sealed bore 118 that a consistent spacing between the outer housing 152 and the channel 148 to maintain the desired shape of channel 148 within the outer housing 152.

1. A deployable sensor system for incorporation on a marine installation, the sensor system comprising:
a sensor mount securable to the marine installation; and
a sensor mounted on the sensor mount; wherein
the sensor mount has a raised configuration and a deployed configuration; and wherein
the sensor is arranged to be held rigidly in place below a hull of the marine installation when the sensor mount is in the deployed configuration and the sensor mount is arranged to be rigidly hold the sensor in a higher position in the raised configuration than in the deployed configuration.

2. A marine installation having the sensor system according to claim 1 incorporated thereon.

3. The marine installation according to claim 2, wherein the marine installation includes an external recess, a feedthrough and/or a moonpool in the hull for receiving the sensor mount and/or accessing the sensor when the sensor mount is in the raised configuration.

4. The marine installation according to claim 2 or claim 3 including a plurality of sensor mounts secured to the marine installation, each sensor mount having a raised configuration and a deployed configuration and each sensor mount having at least one sensor mounted thereon.

5. The marine installation according to claim 4, wherein at least one sensor mount is deployable independently of at least one other sensor mount.

6. The marine installation according to any one of claims 2 to 5, wherein the, some, or each sensor mount(s) is/are removeable from the marine installation.

7. The sensor system or marine installation according to any one of the preceding claims, wherein the or each sensor mount is slidably secured to the marine installation.

8. The sensor system or marine installation according to any one of the preceding claims, wherein the transition between the raised and deployed configurations of the, some, or each sensor mount(s) include(s) the sensor mount(s) sliding in a vertical direction relative to the marine installation.

9. The sensor system or marine installation according to any one of the preceding claims, wherein the sensor mount is selectively lockable at one or more configurations intermediate between the raised and deployed configurations.

10. The sensor system or marine installation according to any one of the preceding claims, wherein the, some, or each sensor(s) include(s) one or more of:
a camera;
a sonar system; and/or
a wildlife detector.

11. The sensor system or marine installation according to any one of the preceding claims, wherein the, some, or each of the sensor(s) is/are located adjacent the hull of the marine installation when its/their respective sensor mount(s) is/are in the raised configuration.

12. The sensor system or marine installation according to any one of the preceding claims, wherein the, some, or each of the sensor(s) is/are located within the hull of the marine installation when its/their respective sensor mount(s) is/are in the raised configuration.

13. The sensor system or marine installation according to any one of the preceding claims, wherein the, some, or each sensor(s) is/are rotatable relative to the marine installation.

14. The sensor system or marine installation according to claim 13, wherein each rotatable sensor is selectively lockable at two or more orientations.

15. The sensor system or marine installation according to any one of the preceding claims, wherein the, some, or each of the sensor mount(s) is/are an elongate, rigid beam.

16. The sensor system or marine installation according to any one of the preceding claims, wherein the, some, or each sensor mount(s) include(s) one or more lumens for allowing control signals, sensor data, electrical power and/or motive power to be transmitted between the marine installation and the sensor(s).

17. The sensor system or marine installation according to any one of the preceding claims, wherein an outer surface of the, some, or each sensor mount(s) include(s) a hydrodynamic fairing.

18. The sensor system or marine installation according to any one of the preceding claims, wherein the, some, or each sensor(s) is/are removeable from its/their respective sensor mount(s).

19. The sensor system or marine installation according to any one of the preceding claims, further comprising an on-board processor for processing output from the, some, or each sensor(s).

20. The sensor system or marine installation according to any one of the preceding claims, wherein the sensor(s) is/are arranged to monitor sensitive and/or fragile parts of the marine installation.

21. The sensor system or marine installation according to claim 20, wherein, in response to a detection by the sensor(s) that an object is likely to collide with the sensitive and/or fragile parts of the marine installation, the sensor system is configured to issue an alert to an operator and/or take appropriate action to minimise damage.

22. The sensor system or marine installation according to any one of the preceding claims, wherein the marine installation is a flowing-water-driven turbine assembly.

23. The sensor system or marine installation according to any one of the preceding claims, wherein the, some, or each sensor(s) has/have a protective cage for protecting the sensor.

24. A method of installation of a marine installation according to claim 2 or any claim dependent thereon, the method comprising the steps of:
(a) positioning the or each sensor mount in its/their raised configuration;
(b) towing the marine installation to an installation site; and
(c) installing the marine installation at the installation site.

25. The method of claim 24, further comprising the steps of:
(d) deploying the sensor mount(s) to perform data collection using the sensor(s); and
(e) removing the sensors for use elsewhere once sufficient data has been collected.
